(19) United States
(12) Patent Application Publication
(10) Pub. No.: US 2025/0371214 A1
(43) Pub. Date: Dec. 4, 2025

(54) POLAR-REGION SHIP NAVIGATION SIMULATION SYSTEM

(71) Applicant: HARBIN ENGINEERING UNIVERSITY, Harbin (CN)

(72) Inventors: Yanzhuo XUE, Harbin (CN); Yingfei ZAN, Harbin (CN); Chuanyue XU, Harbin (CN); Yicheng ZHANG, Harbin (CN); Ruinan GUO, Harbin (CN); Tongqi YANG, Harbin (CN); Zhongming LI, Harbin (CN); Duanfeng HAN, Harbin (CN)

(73) Assignee: HARBIN ENGINEERING UNIVERSITY, Harbin (CN)

(21) Appl. No.: 19/280,247

(22) Filed: Jul. 25, 2025

Related U.S. Application Data
(63) Continuation of application No. PCT/CN2025/088183, filed on Apr. 10, 2025.

(30) Foreign Application Priority Data
May 29, 2024 (CN) 202410679405.6

(51) Int. Cl. G06F 30/20; B63B 49/00

(52) U.S. Cl. CPC G06F 30/20; B63B 49/00; B63B 2211/06

(57) ABSTRACT

It provides the following solutions: the system includes subsystems such as an integrated management and evaluation subsystem, and constructs a ship six-degree-of-freedom motion model. A thrust calculation model is built for the problem of propeller thrust affected by broken ice during the propulsion process. By treating broken ice as independent moving objects, the motion of broken ice is solved to obtain the relative motion speed between the ship and broken ice. The influence of broken ice on propeller performance is considered by incorporating the relative speed between the ship and broken ice into the propeller modeling process, which acts on the aforementioned model. The annular crack method is used to determine the breaking shape of level ice, and the generated broken ice is close to real-world conditions.

### CROSS-REFERENCE TO RELATED APPLICATIONS

This application is the U.S. continuation application of International Application No. PCT/CN2025/088183 filed on 10 Apr. 2025 which designated the U.S. and claims priority to Chinese Application No. filed on CN202410679405.6 filed on 29 May 2024, the entire contents of each of which are hereby incorporated by reference.

### TECHNICAL FIELD

The present invention belongs to the technical field of ship and ocean engineering, and particularly to a polar-region ship navigation simulation system and modeling method.

### BACKGROUND

With the opening of an Arctic shipping route, the safety problem of polar-region ship navigation is becoming more and more serious. The dangerous environment, navigation characteristics and ice load in the polar-region are closely related to the safety and efficiency of polar-region ship navigation. A polar-region ship navigation simulation system may be used for providing specific simulated navigation training for the crew in ice area navigation, and reserving a theoretical sailing foundation and practical skills for entering polar-region navigation, so as to further understand the special environment of the sea area in the polar-region, and minimize the navigation risk. The physical realism, behavioral realism and environmental realism of the polar-region ship navigation simulation system are important factors that affect the training effect.

The Patent document CN116011294A discloses a construction method of a six-degree-of-freedom ROV operation simulation platform, and puts forward that a construction method of a six-degree-of-freedom dynamic model for a mother ship cannot consider the factors affecting ship navigation in polar-region environment, thus being not suitable for the calculation of a polar-region ship navigation motion. Based on the problems existing in the prior art, a polar-region ship six-degree-of-freedom motion simulation model and a ship-flat ice/broken ice collision simulation model are constructed to form a simulation system, so as to ensure the physical realism, behavioral realism and environmental realism of the ship, ice and marine environment, which is of great significance for improving the performance of the simulation system and the training functionality.

The existing polar-region ship navigation simulation system has the following shortcomings.
1. Insufficient influence of ice on hydrodynamic force: an influence of ice on a motion performance of a ship is mainly considered in the polar-region ship navigation, and there is a lack of consideration of an influence of broken ice on a propeller thrust.
2. Contradiction between real-time performance and accuracy of calculation of an ice load: it is difficult to ensure real-time requirements when the ice load is calculated by a discrete element or finite element method, and an empirical formula method has a fast calculation speed but cannot generate actual broken ice.
3. Single material parameters of ice: material characteristics of polar-region ice are not single in the sea area, so that the data of ice layer thickness, density and strength need to be changed in real time.

### SUMMARY

The present invention aims at that following technical problems in the prior art: firstly, insufficient influence of ice on hydrodynamic force: an influence of ice on a motion performance of a ship is mainly considered in polar-region ship navigation, and there is a lack of consideration of an influence of broken ice on a propeller thrust; and secondly, contradiction between real-time performance and accuracy of calculation of ice load: it is difficult to ensure real-time requirements when the ice load is calculated by a discrete element or finite element method, and an empirical formula method has a fast calculation speed but cannot generate actual broken ice.

To overcome all the deficiencies in the prior art, the present invention provides the following technical solution:
Solution 1, a polar-region ship navigation simulation system, wherein the polar-region ship navigation simulation system comprises a comprehensive management and evaluation subsystem, a ship sailing control simulation subsystem, a polar-region working environment simulation subsystem, a polar-region ship real-time motion simulation subsystem and a polar-region ship navigation vision simulation subsystem;
the comprehensive management and evaluation subsystem comprises trainer software and electronic chart software, wherein the trainer software is used for providing input conditions of polar-region environment and ice layer distribution for the polar-region working environment simulation subsystem; and the electronic chart software is used for providing an initial position of a ship and a route plan for the polar-region ship motion simulation subsystem in real time, and controlling a simulation process of the simulation system at the same time;
the ship real-time motion simulation subsystem comprises a thruster operation module, a steering engine operation module and a sailing and navigation control module; and is used for providing a rotating speed of a propeller, a rudder angle and a fault control instruction of a thruster for the polar-region ship real-time motion simulation subsystem, and used for simulating ship navigation control;
the polar-region working environment simulation subsystem comprises a wind speed module, a wave field module, a flow speed module and an ice field module; and
calculates a polar-region environment load, an ice load, and data of ice breaking and motion by constructing a ship-flat ice collision model and a ship-broken ice collision model;
the polar-region ship real-time motion simulation subsystem comprises a propeller module, a rudder module and a ship module, and calculates a ship motion considering influences of wind, wave, current and ice loads by constructing a ship six-degree-of-freedom motion simulation model; and
the polar-region ship navigation vision simulation subsystem receives the data of ice breaking and motion calculated by the polar-region working environment simulation subsystem and data of the ship motion calculated by the polar-region ship real-time motion simulation subsystem, and is used for displaying and updating scenes of polar-region navigation, atmosphere, ocean and ice field in real time.

Furthermore, wherein the polar-region ship navigation vision simulation subsystem comprises a polar-region ship motion simulation driving module, a sea ice motion simulation driving module, a polar-region environment simulation module and a polar-region navigation auxiliary information display module;
the polar-region ship motion simulation driving module is configured for receiving and updating a motion posture in polar-region ship navigation in real time;
the sea ice motion simulation driving module is configured for receiving and updating distribution of floating ice in a ship navigation area in real time;
the polar-region environment simulation module is configured for synchronously updating a polar-region environment according to a trainer instruction; and
the polar-region navigation auxiliary information display module is configured for dynamically displaying an ice layer thickness and an interference distance in vision.

A polar-region ship navigation simulation modeling method, the polar-region ship navigation simulation modeling method comprises the following steps:
first step: setting environment conditions, sea ice conditions, the initial position of the ship and an expected navigation trajectory through the trainer software and the electronic chart software of the comprehensive management and evaluation subsystem, and issuing a simulation task;
second step: according to the simulation task issued in the first step, calculating, by the polar-region environment simulation subsystem, wind, wave and current loads through the wind speed module, the wave field module and the flow speed module according to the set environment conditions, traversing a ship waterplane boundary point and nearby flat ice and broken ice boundary points by a multi-thread parallel programming method, and detecting a ship-ice contact situation;
third step: on the basis of detecting the ship-ice contact situation in the second step, when the ship-ice contact is detected, calculating, by the ice field module, breaking of flat ice, a motion of broken ice, and total loads of the flat ice and the broken ice based on the ship-flat ice collision model and the ship-broken ice collision model according to distribution of sea ice, an ice layer thickness and a material property;
fourth step: taking, by the polar-region ship real-time motion simulation subsystem, the wind load, the wave load, a relative speed between the ship and an ocean current, the total load of the flat ice and the total load of the broken ice calculated by the polar-region environment simulation subsystem as environment load inputs, taking the rotating speed and the rudder angle provided by the polar-region ship sailing control simulation subsystem as control instruction inputs, and constructing a propeller model, a rudder model and a polar-region ship six-degree-of-freedom motion simulation model respectively; and
fifth step: generating, by the polar-region ship navigation vision simulation subsystem, a three-dimensional scene according to a navigation sea area, and wind, wave and current environmental conditions issued by the trainer software, updating distribution of the flat ice and the broken ice according to data of the breaking characteristic of the flat ice and data of the motion of the broken ice calculated by the polar-region environment simulation subsystem, and updating a polar-region ship navigation simulation three-dimensional scene according to data of the ship navigation motion calculated by the polar-region ship real-time motion simulation subsystem.

Furthermore, wherein the third step further comprises a step of calculating a ship-ice contact area, a compression force and friction force between the ship and the ice, and a bending failure load of the flat ice respectively, judging a breaking situation of the flat ice, and expressing shape characteristics of the broken ice falling off after the flat ice is broken through a radius of the broken ice falling off and an opening angle of an ice wedge.

Furthermore, wherein the calculating the ship-ice contact area, the compression force and friction force between the ship and the ice, and the bending failure load of the flat ice, judging the breaking situation of the flat ice, and expressing the shape characteristics of the broken ice falling off after the flat ice is broken through the radius of the broken ice falling off and the opening angle of the ice wedge in the third step, specifically comprises the following steps:
S31: firstly, judging a shape of a ship-ice contact part through the ice layer thickness hᵢ, an included angle φ between a normal direction outside the ship and a downward vertical axis at the ship-ice contact part, and a compression depth L_{d}, and calculating a ship-flat ice contact area A_{c}, by the ship-flat ice collision model as follows:

$${A}_{c} = \{ \begin{matrix}\frac{1}{2} {L}_{h} \frac{{L}_{d}}{cos φ} & , {L}_{d} tan φ \leq {h}_{i} \\ \frac{1}{2} ( {L}_{h} + {L}_{h} \frac{{L}_{d} - \frac{{h}_{i}}{tan φ}}{{L}_{d}} ) \frac{{h}_{i}}{sin φ} , & , {L}_{d} tan φ > {h}_{i}\end{matrix}$$

wherein, Lₕ is a length of a ship boundary where a horizontal ice surface makes contact with an ice boundary; L_{d} is the compression depth of the ship into the ice boundary on the horizontal ice surface; φ is the included angle between the normal direction outside the ship and the downward vertical axis at the ship-ice contact part; and hᵢ is the ice layer thickness;
S32: secondly, calculating the compression force F_{c} and friction force F_{f} between the ship and the ice respectively through the ship-flat ice contact area A_{c} by the ship-flat ice collision model as follows:

$$\begin{matrix}{F}_{c} = {n}_{c} \cdot {σ}_{c} {A}_{c} \\ {F}_{f z} = - {τ}_{c} \cdot {μ}_{f} {F}_{c} {v}_{z} / V \\ {F}_{fl} = - {τ}_{c} \cdot {μ}_{f} {F}_{c} {v}_{l} / V\end{matrix}$$

wherein, n_{c} is a unit normal direction of a ship-ice contact surface; σ_{c} is a compression strength of ice; τ_{c} is a unit tangential direction of the ship-ice contact surface; μ_{f} is a ship-ice friction coefficient; F_{fz} is an upward friction force along the ship-ice contact surface; v_{z} is an upward relative speed between the ship and the ice along the ship-ice contact surface; F_{fl} is a friction force along a horizontal direction of the ship-ice contact surface; vₗ is a relative speed between the ship and the ice along the horizontal direction of the ship-ice contact surface; and V is a total speed of the ship sliding relative to the ice;
S33: finally, obtaining that the total load of the flat ice borne by the ship in a co-moving coordinate system of a mother ship is τ_{pice}:

$${τ}_{pice} = {[ {F}_{fz} , {F}_{c} , {F}_{fl} ]}^{T} {R}_{c}^{b}$$

wherein,

$${R}_{c}^{b}$$

is a transformation matrix between local coordinates of the ship-ice contact surface and coordinates of the ship;

S34: in order to judge a fracture situation and shape characteristics of the flat ice making collision contact with the ship, calculating the bending failure load P_{f} of the flat ice by the ship-broken ice collision model as follows:

$${P}_{f} = {{C}_{f} ( \frac{θ}{π} )}^{2} {σ}_{f} {h}_{i}^{2}$$

wherein, C_{f} is an empirical parameter; σ_{f} is an ice bending strength; θ is the opening angle of the ice wedge at the ship-ice contact part, and hᵢ is the ice layer thickness; and
when a resultant force F_{z}=−F_{fz} sin φ+F_{c} cos φ of the compression force and friction force between the ship and the ice in a vertical direction is greater than a bending failure limit load P_{f}, the flat ice is broken, and the broken ice falls off;
S35: when the broken ice falling off is fan-shaped, expressing the shape characteristics of the broken ice falling off through a breaking radius and the opening angle of the ice wedge at the ship-ice contact part by a circular crack method, wherein a calculation model for the breaking radius R is as follows:

$$R = {{C}_{l} [ \frac{{{Eh}_{i}}^{3}}{12 ( 1 - {v}^{2} ) {ρ}_{w} g} ]}^{\frac{1}{4}} ( 1 + {C}_{v} {v}_{n} )$$

wherein, Cₗ and Cᵥ are empirical coefficients, v is a Poisson's ratio, and E is an ice elastic modulus; ρ_{w} is a seawater density; and vₙ is a relative normal speed between a discrete point of a waterline and a discrete point of a flat ice boundary; and
S36: after determining the breaking radius and the opening angle of the ice wedge at the ship-ice contact part in the shape characteristics of the broken ice falling off, fracturing the broken ice falling off according to the distribution of sea ice issued by the trainer software, updating the flat ice boundary, expressing the distribution of the flat ice, and generating a boundary for the broken ice falling off from the flat ice.

Furthermore, wherein the, when the ship-ice contact is detected, calculating, by the ice field module, the breaking of the flat ice, the motion of the broken ice, and the total loads of the flat ice and the broken ice based on the ship-flat ice collision model and the ship-broken ice collision model according to the distribution of sea ice, the ice layer thickness and the material property in the third step, is implemented by a method comprising:
S311: firstly, constructing a dynamic model of each piece of broken ice in the ship navigation area:

$$\{ \begin{matrix}{F}_{s} = {m}_{s} \frac{{dv}_{s}}{dt} \\ {T}_{s} = {J}_{s} \frac{d {ω}_{s}}{dt} + {ω}_{s} \times ( {J}_{s} \cdot {ω}_{s} )\end{matrix}$$

wherein, Fₛ is a combined external force generated by wind, wave and current forces exerted on the broken ice and contact forces with the flat ice, the broken ice and the ship; Tₛ is a combined external force moment; mₛ is a total mass of the broken ice calculated currently; and Jₛ is a total inertia tensor; and
inputting values of Fₛ, Tₛ, mₛ and Jₛ to obtain a speed vector vₛ of the motion of the broken ice; and an angular speed vector ωₛ, integrating to obtain displacement and rotation motion data of each piece of broken ice, and expressing the distribution of the broken ice;
S322: calculating a contact between solid surfaces of the broken ice by a linear spring damping system, wherein a calculation model for ship-broken ice, broken ice-broken ice and broken ice-flat ice contact forces near the ship is as follows:

$${F}_{n} = - {kd}_{n} - η {v}_{n}$$

$${F}_{t} = \{ \begin{matrix}- {kd}_{t} - η {v}_{t} , & \vert {d}_{t} \vert < \vert {d}_{n} \vert μ \\ \vert {kd}_{n} \vert μ \cdot {n}_{t} , & \vert {d}_{t} \vert \geq \vert {d}_{n} \vert μ\end{matrix}$$

wherein, k is a material elastic coefficient of ice; η is a material damping coefficient of ice; dₙ is a normal overlapping distance between the ice and other object, vₙ is a normal overlapping speed, dₜ is a tangential overlapping distance, vₜ is a tangential overlapping speed, and μ is a friction coefficient; nₜ is a tangential unit direction of a broken ice boundary; and Fₙ is an inward normal contact force of the ice boundary, and Fₜ is a tangential contact force along the ice boundary; and
S333: finally, obtaining that the total load of the broken ice borne by the ship in a co-moving coordinate system of a mother ship is τ_{sice}:

$${τ}_{pice} = {[ {F}_{t} , {F}_{n} , 0 ]}^{T} {R}_{c}^{b}$$

wherein

$${R}_{c}^{b}$$

is a transformation matrix is between local coordinates of the ship-ice contact surface and coordinates of the ship.

Furthermore, wherein the taking the rotating speed and the rudder angle provided by the polar-region ship sailing control simulation subsystem as the control instructions to calculate a propeller thrust affected by the ice in the fourth step, that is, the calculation of the propeller thrust T_{P} affected by the broken ice, is implemented by a method as follows:

$${T}_{P} = ( 1 - {t}_{p} ) {ρ}_{w} {{n}_{p}}^{2} {{D}_{p}}^{4} {K}_{T} ( \frac{( 1 - {W}_{p} ) u}{n \cdot {D}_{p}} )$$

wherein, tₚ is a deduction of the propeller thrust; ρ_{w} is a seawater density; nₚ is a rotating speed of the propeller; Dₚ is a diameter of the propeller; K_{T} is a thrust coefficient; Wₚ is a wake speed; u is a relative speed between the ship and the broken ice; and T_{P} is the propeller thrust.

Furthermore, wherein the constructing the ship six-degree-of-freedom motion simulation model in the fourth step, is implemented by a method as follows:

$${M}_{0} {\dot{v}}_{0} + {C}_{RB 0} {v}_{0} + {C}_{A 0} {v}_{r 0} + {D}_{0} {v}_{r 0} + {\int }_{0}^{t} {K}_{0} ( t - γ ) [ {v}_{0} ( γ ) - {Ue}_{1} ] d γ + {G}_{0} η = {τ}_{wind 0} + {τ}_{wave 0} + {τ}_{P} + {τ}_{R} + {τ}_{ice}$$

wherein, M₀ is a sum of a mass of the mother ship and an additional mass; C_{RB0} is a centripetal force of a rigid body and a liquid body, and C_{A0} is a Coriolis force matrix; vᵣ₀ is a relative speed between the mother ship and the ocean current in the co-moving coordinate system; D₀ is a damping matrix; K₀(t−γ) is a time delay function, wherein t is simulation time and γ is an integral variable; U is a longitudinal navigation speed of the mother ship; e₁ is a longitudinal unit vector; G₀ is a stiffness matrix of the mother ship; τ_{wind0} is the wind load; τ_{wave0} is the wave load; τ_{P} is the propeller thrust; τ_{R} is the rudder force of the ship; and τ_{ice} is a total ice load, comprising a flat ice load τ_{pice} and a broken ice load τ_{sice}; and
solving to obtain an acceleration \dot{v}₀, and a speed v₀ of polar-region ship navigation, and integrating by fourth-order Runge-Kutta to obtain a posture of the ship motion.

Furthermore, wherein the generating, by the polar-region ship navigation vision simulation subsystem, the three-dimensional scene according to the navigation sea area, and the wind, wave and current environmental conditions issued by the trainer software in the fifth step, is implemented by a method comprising: simulating, by the polar-region ship navigation vision simulation subsystem, the three-dimensional scene based on a three-dimensional engine, loading the initial position of the ship and the initial distribution of the flat ice and the broken ice through the navigation sea area and the wind, wave and current environmental conditions issued by the trainer software in the simulation process, and driving the three-dimensional engine to render a three-dimensional model of marine environment, atmospheric environment, an ice area and the ship to generate the three-dimensional scene.

The present invention has the beneficial effects.

According to the present invention, the ship six-degree-of-freedom motion simulation model is constructed aiming at the problem of the ice load in ice area ship navigation, wherein, compared with the prior art, the ship six-degree-of-freedom motion simulation model constructed in the present invention is suitable for polar-region environment.

According to the present invention, the thrust calculation model is constructed aiming at the problem that the propeller is affected by the broken ice in the propulsion process, the motion of the broken ice is solved by taking the broken ice as an independent moving object and the relative motion speed between the ship and the broken ice is obtained, and the influence of the broken ice on the performance of the propeller is considered by taking the relative speed between the ship and the broken ice into account in the propeller modeling process, which acts on the ship six-degree-of-freedom motion response model.

According to the present invention, the calculation of the ice load comprises the flat ice load and the broken ice load, and a broken shape of the flat ice is determined by the annular crack method, so that a calculation speed is fast and a simulation result is more accurate, and the generated broken ice is close to a real situation.

According to the present invention, in ship-flat ice contact point detection, a multi-process parallel method is used to traverse intersection inspection of a ship waterplane boundary point line segment and a flat ice boundary point line segment, so that the calculation efficiency of the simulation system is improved.

According to the present invention, an ice crack and the broken ice generated after an icebreaker acts on the ice layer are displayed and updated in real time, the shape and size of the crack, and the shape, motion and distribution of the broken ice are all calculated by the ship-flat ice/broken ice collision simulation model, which conform to an ice dynamic law after an ship-ice action, thus achieving higher behavioral and environmental realism.

Therefore, the present invention is also applicable to the field of providing specific navigation simulation training for the crew in polar-region navigation.

### BRIEF DESCRIPTION OF THE DRAWINGS

FIG. 1 is a schematic diagram of assembly of a polar-region ship navigation simulation system in First Embodiment.

FIG. 2 is a flow chart of a polar-region ship navigation simulation modeling method in Third Embodiment.

### DETAILED DESCRIPTION

In order to make the objectives, technical solutions and advantages of embodiments of the present application more clear, the technical solutions in the embodiments of the present application will be illustrated clearly and completely hereinafter with reference to the drawings in the embodiments of the present application. Apparently, the embodiments described are merely some but not all of the embodiments of the present application.

First embodiment: this embodiment provides a polar-region ship navigation simulation system, wherein the polar-region ship navigation simulation system comprises a comprehensive management and evaluation subsystem, a ship sailing control simulation subsystem, a polar-region working environment simulation subsystem, a polar-region ship real-time motion simulation subsystem and a polar-region ship navigation vision simulation subsystem;
the comprehensive management and evaluation subsystem comprises trainer software and electronic chart software, wherein the trainer software is used for providing input conditions of polar-region environment and ice layer distribution for the polar-region working environment simulation subsystem; and the electronic chart software is used for providing an initial position of a ship and a route plan for the polar-region ship motion simulation subsystem in real time, and controlling a simulation process of the simulation system at the same time;
the ship real-time motion simulation subsystem comprises a thruster operation module, a steering engine operation module and a sailing and navigation control module; and is used for providing a rotating speed of a propeller, a rudder angle and a fault control instruction of a thruster for the polar-region ship real-time motion simulation subsystem, and used for simulating ship navigation control;
the polar-region working environment simulation subsystem comprises a wind speed module, a wave field module, a flow speed module and an ice field module; and a ship-flat ice collision model and calculates a polar-region environment load, an ice load, and data of ice breaking and motion by constructing a ship-broken ice collision model;
the polar-region ship real-time motion simulation subsystem comprises a propeller module, a rudder module and a ship module, and calculates a ship motion considering influences of wind, wave, current and ice loads by constructing a ship six-degree-of-freedom motion simulation model; and
the polar-region ship navigation vision simulation subsystem receives the data of ice breaking and motion calculated by the polar-region working environment simulation subsystem and data of the ship motion calculated by the polar-region ship real-time motion simulation subsystem, and is used for displaying and updating scenes of polar-region navigation, atmosphere, ocean and ice field in real time.

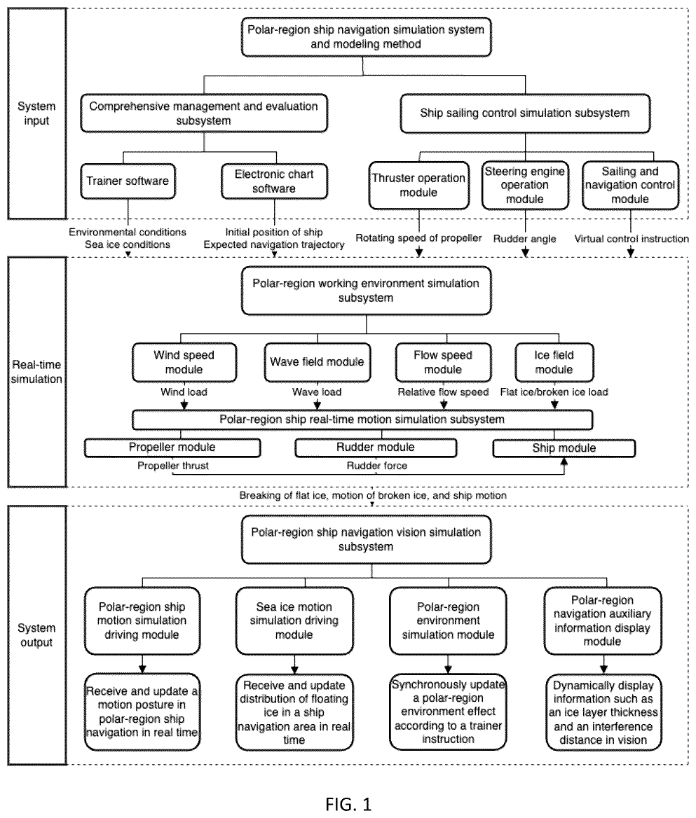

This embodiment is illustrated with reference to FIG. 1. The polar-region ship navigation simulation system comprises the comprehensive management and evaluation subsystem, the polar-region ship sailing control simulation subsystem, the polar-region environment simulation subsystem, the polar-region ship real-time motion simulation subsystem and the polar-region ship navigation vision simulation subsystem. Based on a TCP/UDP network, the systems realize data transmission of various communication mechanisms by publication/subscription, client/server and other models.

The comprehensive management and evaluation subsystem and the polar-region ship sailing control simulation subsystem provide environmental conditions such as a reference height, a wind speed, a frequency, a significant wave height, a period, a water depth, a tide flow speed and a flow direction, and sea ice conditions such as distribution of sea ice, an ice layer thickness and a material property in a navigation sea area, set simulation working conditions such as an initial position of a ship and an expected navigation trajectory, and realize a function of inputting a rotating speed of a propeller, a rudder angle and a fault control instruction of a thruster.

The polar-region environment simulation subsystem and the polar-region ship real-time motion simulation subsystem provide wind, wave, current and ice loads, and breaking of flat ice and a motion of broken ice, consider the propeller thrust and the rudder force affected by the broken ice, and consider a function of calculating a polar-region ship navigation motion affected by the wind, wave, current and ice loads.

Second Embodiment: this embodiment further defines the polar-region ship navigation simulation system in First embodiment, wherein the polar-region ship navigation vision simulation subsystem comprises a polar-region ship motion simulation driving module, a sea ice motion simulation driving module, a polar-region environment simulation module and a polar-region navigation auxiliary information display module;
the polar-region ship motion simulation driving module is configured for receiving and updating a motion posture in polar-region ship navigation in real time;
the sea ice motion simulation driving module is configured for receiving and updating distribution of floating ice in a ship navigation area in real time;
the polar-region environment simulation module is configured for synchronously updating a polar-region environment according to a trainer instruction; and
the polar-region navigation auxiliary information display module is configured for dynamically displaying an ice layer thickness and an interference distance in vision.

The polar-region ship navigation vision simulation subsystem in this embodiment updates a polar-region ship navigation simulation scene in real time according to a position and a posture of the ship calculated by the polar-region ship real-time motion simulation subsystem, assists an operator to judge an ice area navigation state of the ship, and divides a polar-region three-dimensional scene into two sea ice driving modes, comprising flat ice area ice-breaking navigation and broken ice area ice-breaking navigation. In the simulation of the flat ice area ice-breaking navigation, the distribution of the flat ice and the broken ice in the navigation area is updated according to the ice crack and the motion of the broken ice calculated by the ship-ice collision simulation model. In the simulation of the broken ice area ice-breaking navigation, a geometrical shape of floating ice in a shipping route is randomly generated, a position of the floating ice is updated according to data of the motion of the broken ice, and illumination, ice and wave effects are simulated according to environmental conditions of the navigation sea area issued by the comprehensive management and evaluation subsystem.

Third Embodiment: this embodiment provides a polar-region ship navigation simulation modeling method, wherein the polar-region ship navigation simulation modeling method is implemented by the system according to any one of First Embodiment to Second Embodiment, and the polar-region ship navigation simulation modeling method comprises the following steps:
first step: setting environment conditions, sea ice conditions, the initial position of the ship and an expected navigation trajectory through the trainer software and the electronic chart software of the comprehensive management and evaluation subsystem, and issuing a simulation task;
second step: according to the simulation task issued in the first step, calculating, by the polar-region environment simulation subsystem, wind, wave and current loads through the wind speed module, the wave field module and the flow speed module according to the set environment conditions, traversing a ship waterplane boundary point and nearby flat ice and broken ice boundary points by a multi-thread parallel programming method, and detecting a ship-ice contact situation;
third step: on the basis of detecting the ship-ice contact situation in the second step, when the ship-ice contact is detected, calculating, by the ice field module, breaking of flat ice, a motion of broken ice, and total loads of the flat ice and the broken ice based on the ship-flat ice collision model and the ship-broken ice collision model according to distribution of sea ice, an ice layer thickness and a material property;
fourth step: taking, by the polar-region ship real-time motion simulation subsystem, the wind load, the wave load, a relative speed between the ship and an ocean current, the total load of the flat ice and the total load of the broken ice calculated by the polar-region environment simulation subsystem as environment load inputs, taking the rotating speed and the rudder angle provided by the polar-region ship sailing control simulation subsystem as control instruction inputs, and constructing a propeller model, a rudder model and a polar-region ship six-degree-of-freedom motion simulation model respectively; and
fifth step: generating, by the polar-region ship navigation vision simulation subsystem, a three-dimensional scene according to a navigation sea area, and wind, wave and current environmental conditions issued by the trainer software, updating distribution of the flat ice and the broken ice according to data of the breaking characteristic of the flat ice and data of the motion of the broken ice calculated by the polar-region environment simulation subsystem, and updating a polar-region ship navigation simulation three-dimensional scene according to data of the ship navigation motion calculated by the polar-region ship real-time motion simulation subsystem.

Fourth Embodiment: this embodiment further defines the polar-region ship navigation simulation modeling method according to Third Embodiment, wherein the third step further comprises a step of calculating a ship-ice contact area, a compression force and friction force between the ship and the ice, and a bending failure load of the flat ice respectively, judging a breaking situation of the flat ice, and expressing shape characteristics of the broken ice falling off after the flat ice is broken through a radius of the broken ice falling off and an opening angle of an ice wedge.

Fifth Embodiment: this embodiment further defines the polar-region ship navigation simulation modeling method according to Fourth Embodiment, wherein the calculating the ship-ice contact area, the compression force and friction force between the ship and the ice, and the bending failure load of the flat ice respectively, judging the breaking situation of the flat ice, and expressing the shape characteristics of the broken ice falling off after the flat ice is broken through the radius of the broken ice falling off and the opening angle of the ice wedge in the third step, specifically comprises the following steps:
S31: firstly, judging a shape of a ship-ice contact part through the ice layer thickness hᵢ, an included angle φ between a normal direction outside the ship and a downward vertical axis at the ship-ice contact part, and a compression depth L_{d}, and calculating a ship-flat ice contact area A_{c} by the ship-flat ice collision model as follows:

$${A}_{c} = \{ \begin{matrix}\frac{1}{2} {L}_{h} \frac{{L}_{d}}{cos φ} , & {L}_{d} tan φ \leq {h}_{i} \\ \frac{1}{2} ( {L}_{h} + {L}_{h} \frac{{L}_{d} - \frac{{h}_{i}}{tan φ}}{{L}_{d}} ) \frac{{h}_{i}}{sin φ} , & {L}_{d} tan φ > {h}_{i}\end{matrix}$$

wherein, Lₕ is a length of a ship boundary where a horizontal ice surface makes contact with an ice boundary; L_{d} is the compression depth of the ship into the ice boundary on the horizontal ice surface; φ is the included angle between the normal direction outside the ship and the downward vertical axis at the ship-ice contact part; and hᵢ is the ice layer thickness;
S32: secondly, calculating the compression force F_{c} and friction force F_{f} between the ship and the ice respectively through the ship-flat ice contact area A_{c} by the ship-flat ice collision model as follows:

$${F}_{c} = {n}_{c} \cdot {σ}_{c} {A}_{c}$$

$${F}_{fz} = - {τ}_{c} \cdot {μ}_{f} {F}_{c} {v}_{z} / V$$

$${F}_{fl} = - {τ}_{c} \cdot {μ}_{f} {F}_{c} {v}_{l} / V$$

wherein, n_{c} is a unit normal direction of a ship-ice contact surface; σ_{c} is a compression strength of ice; τ_{c} is a unit tangential direction of the ship-ice contact surface; μ_{f} is a ship-ice friction coefficient; F_{fz} is an upward friction force along the ship-ice contact surface; v_{z} is an upward relative speed between the ship and the ice along the ship-ice contact surface; Fₙ is a friction force along a horizontal direction of the ship-ice contact surface; vₗ is a relative speed between the ship and the ice along the horizontal direction of the ship-ice contact surface; and V is a total speed of the ship sliding relative to the ice;
S33: finally, obtaining that the total load of the flat ice borne by the ship in a co-moving coordinate system of a mother ship is τ_{pice}:

$${τ}_{pice} = {[ {F}_{fz} , {F}_{c} , {F}_{fl} ]}^{T} {R}_{c}^{b}$$

wherein, R_{c}^{b} is a transformation matrix between local coordinates of the ship-ice contact surface and coordinates of the ship;
S34: in order to judge a fracture situation and shape characteristics of the flat ice making collision contact with the ship, calculating the bending failure load P_{f} of the flat ice by the ship-broken ice collision model as follows:

$${P}_{f} = {{C}_{f} ( \frac{θ}{π} )}^{2} {σ}_{f} {h}_{i}^{2}$$

wherein, C_{f} is an empirical parameter; σ_{f} is an ice bending strength; θ is the opening angle of the ice wedge at the ship-ice contact part, and hᵢ is the ice layer thickness; and
when a resultant force F_{z}=−F_{fz} sin φ+F_{c} cos φ of the compression force and friction force between the ship and the ice in a vertical direction is greater than a bending failure limit load P_{f}, the flat ice is broken, and the broken ice falls off;
S35: when the broken ice falling off is fan-shaped, expressing the shape characteristics of the broken ice falling off through a breaking radius and the opening angle of the ice wedge at the ship-ice contact part by a circular crack method, wherein a calculation model for the breaking radius R is as follows:

$$R = {{C}_{l} [ \frac{{{Eh}_{i}}^{3}}{12 ( 1 - {v}^{2} ) {ρ}_{w} g} ]}^{\frac{1}{4}} ( 1 + {C}_{v} {v}_{n} )$$

wherein, Cₗ and Cᵥ are empirical coefficients, v is a Poisson's ratio, and E is an ice elastic modulus; ρ_{w} is a seawater density; and vₙ is a relative normal speed between a discrete point of a waterline and a discrete point of a flat ice boundary; and
S36: after determining the breaking radius and the opening angle of the ice wedge at the ship-ice contact part in the shape characteristics of the broken ice falling off, fracturing the broken ice falling off according to the distribution of sea ice issued by the trainer software, updating the flat ice boundary, expressing the distribution of the flat ice, and generating a boundary for the broken ice falling off from the flat ice.

Sixth Embodiment: this embodiment further defines the polar-region ship navigation simulation modeling method according to Third Embodiment, wherein the, when the ship-ice contact is detected, calculating, by the ice field module, the breaking of the flat ice, the motion of the broken ice, and the total loads of the flat ice and the broken ice based on the ship-flat ice collision model and the ship-broken ice collision model according to the distribution of sea ice, the ice layer thickness and the material property in the third step, is implemented by a method comprising:

S311: firstly, constructing a dynamic model of each piece of broken ice in the ship navigation area:

$$\{ \begin{matrix}{F}_{s} = {m}_{s} \frac{{dv}_{s}}{dt} \\ {T}_{s} = {J}_{s} \frac{d {ω}_{s}}{dt} + {ω}_{s} \times ( {J}_{s} \cdot {ω}_{s} )\end{matrix}$$

wherein, Fₛ is a combined external force generated by wind, wave and current forces exerted on the broken ice and contact forces with the flat ice, the broken ice and the ship; Tₛ is a combined external force moment; mₛ is a total mass of the broken ice calculated currently; and Jₛ is a total inertia tensor; and
inputting values of Fₛ, Tₛ, mₛ and Jₛ to obtain a speed vector vₛ of the motion of the broken ice; and an angular speed vector ωₛ, integrating to obtain displacement and rotation motion data of each piece of broken ice, and expressing the distribution of the broken ice;
S322: calculating a contact between solid surfaces of the broken ice by a linear spring damping system, wherein a calculation model for ship-broken ice, broken ice-broken ice and broken ice-flat ice contact forces near the ship is as follows:

$${F}_{n} = - {kd}_{n} - η {v}_{n}$$

$${F}_{t} = \{ \begin{matrix}- {kd}_{t} - η {v}_{t} , & \vert {d}_{t} \vert < \vert {d}_{n} \vert μ \\ \vert {kd}_{n} \vert μ \cdot {n}_{t} , & \vert {d}_{t} \vert \geq \vert {d}_{n} \vert μ\end{matrix}$$

wherein, k is a material elastic coefficient of ice; η is a material damping coefficient of ice; dₙ is a normal overlapping distance between the ice and other object, vₙ is a normal overlapping speed, dₜ is a tangential overlapping distance, vₜ is a tangential overlapping speed, and μ is a friction coefficient; nₜ is a tangential unit direction of a broken ice boundary; and Fₙ is an inward normal contact force of the ice boundary, and Fₜ is a tangential contact force along the ice boundary; and
S333: finally, obtaining that the total load of the broken ice borne by the ship in a co-moving coordinate system of a mother ship is τ_{sice}:

$${τ}_{pice} = {[ {F}_{t} , {F}_{n} , 0 ]}^{T} {R}_{c}^{b}$$

wherein,

$${R}_{c}^{b}$$

is a transformation matrix between local coordinates of the ship-ice contact surface and coordinates of the ship.

Seventh Embodiment: this embodiment further defines the polar-region ship navigation simulation modeling method according to Third Embodiment, wherein the taking the rotating speed and the rudder angle provided by the polar-region ship sailing control simulation subsystem as the control instructions to calculate a propeller thrust affected by the ice in the fourth step, that is, the calculation of the propeller thrust T_{P} affected by the broken ice, is implemented by a method as follows:

$${T}_{P} = ( 1 - {t}_{p} ) {ρ}_{w} {{n}_{p}}^{2} {{D}_{p}}^{4} {K}_{T} ( \frac{( 1 - {W}_{p} ) u}{n \cdot {D}_{p}} )$$

wherein, tₚ is a deduction of the propeller thrust; ρ_{w} is a seawater density; nₚ is a rotating speed of the propeller; Dₚ is a diameter of the propeller; K_{T} is a thrust coefficient; Wₚ is a wake speed; u is a relative speed between the ship and the broken ice; and T_{P} is the propeller thrust.

Eighth Embodiment: this embodiment further defines the polar-region ship navigation simulation modeling method according to Third Embodiment, wherein the constructing the ship six-degree-of-freedom motion simulation model in the fourth step, is implemented by a method as follows:

$${M}_{0} {\dot{v}}_{0} + {C}_{RB 0} {v}_{0} + {C}_{A 0} {v}_{r 0} + {D}_{0} {v}_{r 0} + {\int }_{0}^{t} {K}_{0} ( t - γ ) [ {v}_{0} ( γ ) - {Ue}_{1} ] d γ + {G}_{0} η = {τ}_{wind 0} + {τ}_{wave 0} + {τ}_{P} + {τ}_{R} + {τ}_{ice}$$

wherein, M₀ is a sum of a mass of the mother ship and an additional mass; C_{RB0} is a centripetal force of a rigid body and a liquid body, and C_{A0} is a Coriolis force matrix; vᵣ₀ is a relative speed between the mother ship and the ocean current in the co-moving coordinate system; D₀ is a damping matrix; K₀(t−γ) is a time delay function, wherein t is simulation time and γ is an integral variable; U is a longitudinal navigation speed of the mother ship; e₁ is a longitudinal unit vector; G₀ is a stiffness matrix of the mother ship; τ_{wind0} is the wind load; τ_{wave0} is the wave load; τ_{P} is the propeller thrust; τ_{R} is the rudder force of the ship; and τ_{ice} is a total ice load, comprising a flat ice load τ_{pice} and a broken ice load τ_{ice}; and
solving to obtain an acceleration \dot{v}₀, and a speed v₀ of polar-region ship navigation, and integrating by fourth-order Runge-Kutta to obtain a posture of the ship motion.

Ninth Embodiment, this embodiment further defines the polar-region ship navigation simulation modeling method according to Third Embodiment, wherein the generating, by the polar-region ship navigation vision simulation subsystem, the three-dimensional scene according to the navigation sea area, and the wind, wave and current environmental conditions issued by the trainer software in the fifth step, is implemented by a method comprising: simulating, by the polar-region ship navigation vision simulation subsystem, the three-dimensional scene based on a three-dimensional engine, loading the initial position of the ship and the initial distribution of the flat ice and the broken ice through the navigation sea area and the wind, wave and current environmental conditions issued by the trainer software in the simulation process, and driving the three-dimensional engine to render a three-dimensional model of marine environment, atmospheric environment, an ice area and the ship to generate the three-dimensional scene.

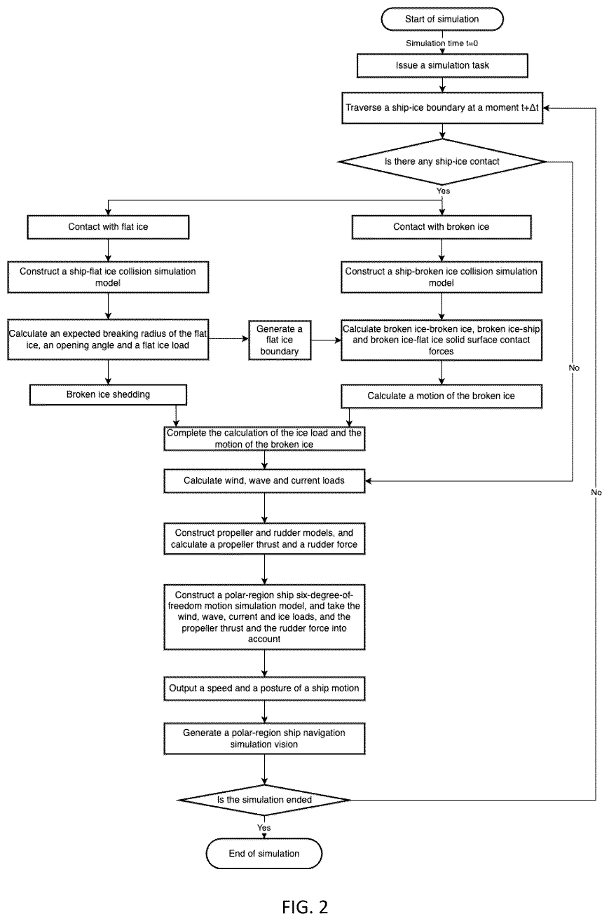

Tenth Embodiment: this embodiment is illustrated with reference to FIG. 2. This embodiment provides the following examples, which are used to explain the Third Embodiment to the Ninth Embodiment above. A specific implementation process is as follows.

In order to verify the effectiveness and effect of the method described in this embodiment, taking a case that a simulated sea area of initial ship navigation only contains the flat ice as an example, an example of the polar-region ship navigation simulation system and modeling method comprises the following steps.

In first step: the comprehensive management and evaluation subsystem is started, environmental conditions such as a reference height, a wind speed, a frequency, a significant wave height, a period, a water depth, a tide flow speed and a flow direction, and sea ice conditions such as distribution of the flat ice, an ice layer thickness, an ice elastic modulus and a seawater density in a navigation sea area are set by the trainer software, an initial position of the ship and an expected navigation trajectory are set by the electronic chart software, and a simulation task is issued.

In second step: the polar-region environment simulation subsystem carries out the following steps according to the current environmental conditions and sea ice conditions:
S21: generating, by the wind speed module, a wind spectrum according to the reference height of the navigation sea area, a one-hour average wind speed and the frequency at the reference height issued by the trainer software, calculating a wind speed distribution time calendar, and calculating the wind load by using a wind load coefficient according to a height on a water surface;
S22: generating, by the wave field module, a wave spectrum and a direction spectrum according to the significant wave height, a characteristic period and a direction spread function issued by the trainer software, calculating a wave elevation time calendar, and calculating the wave load by using a response amplitude operator;
S23: calculating, by the flow speed module, a wind speed-induced flow speed component according to a wind speed and sea conditions, and calculating a flow speed distribution time calendar according to the water depth and the tide flow speed issued by the trainer software to obtain the relative speed between the ship and the ocean current; and
S24: discretizing a waterplane of the ship into boundary points, traversing the ship waterplane boundary point and the nearby flat ice boundary point by the multi-thread parallel programming method, and if an ice boundary point exists in a ship waterplane boundary, indicating a ship-ice contact.

In third step: when ship-ice collision is detected, the ice field module of the polar-region environment simulation subsystem calculates the breaking of the flat ice and the motion of the broken ice falling off, and the total loads of the flat ice and the broken ice falling off based on ship-flat ice collision according to the sea ice conditions such as the distribution of sea ice, the ice layer thickness, the ice elastic modulus and the sea water density issued by the trainer software:
the ship-flat ice collision simulation model is constructed through the ice field module, the ship-ice contact area, the compression force and friction force between the ship and the ice, and the bending failure load of the flat ice are calculated respectively by steps, the breaking situation of the flat ice is judged, and the shape characteristics of the broken ice falling off after the flat ice is broken is expressed through the radius of the broken ice falling off and the opening angle of the ice wedge. This step specifically comprises the following steps:
S31: firstly, judging a shape of a ship-ice contact part through the ice layer thickness hᵢ, an included angle φ between a normal direction outside the ship and a downward vertical axis at the ship-ice contact part, and a compression depth La, and calculating a ship-flat ice contact area A_{c} wherein a calculation model is as follows:

$${A}_{c} = \{ \begin{matrix}\frac{1}{2} {L}_{h} \frac{{L}_{d}}{cos φ} , & {L}_{d} tan φ \leq {h}_{i} \\ \frac{1}{2} ( {L}_{h} + {L}_{h} \frac{{L}_{d} - \frac{{h}_{i}}{tan φ}}{{L}_{d}} ) \frac{{h}_{i}}{sin φ} , & {L}_{d} tan φ > {h}_{i}\end{matrix}$$

wherein, model input conditions comprise that, Lₕ is a length of a ship boundary where a horizontal ice surface makes contact with an ice boundary; L_{d} is the compression depth of the ship into the ice boundary on the horizontal ice surface; φ is the included angle between the normal direction outside the ship and the downward vertical axis at the ship-ice contact part; and hᵢ is the ice layer thickness;
S32: secondly, calculating the compression force F_{c} and friction force F_{f} between the ship and the ice respectively through the contact area A_{c}, wherein a calculation model is as follows:

$${F}_{c} = {n}_{c} \cdot {σ}_{c} {A}_{c}$$

$${F}_{fz} = - {τ}_{c} \cdot {μ}_{f} {F}_{c} {v}_{z} / V$$

$${F}_{fl} = - {τ}_{c} \cdot {μ}_{f} {F}_{c} {v}_{l} / V$$

wherein, input conditions comprise that, n_{c} is a unit normal direction of a ship-ice contact surface; σ_{c} is a compression strength of ice; τ_{c} is a unit tangential direction of the ship-ice contact surface; μ_{f} is a ship-ice friction coefficient; F_{fz} is an upward friction force along the ship-ice contact surface; v_{z} is an upward relative speed between the ship and the ice along the ship-ice contact surface; F_{fl} is a friction force along a horizontal direction of the ship-ice contact surface; vₗ is a relative speed between the ship and the ice along the horizontal direction of the ship-ice contact surface; and V is a total speed of the ship sliding relative to the ice;
S33: finally, obtaining that the total load of the flat ice borne by the ship in a co-moving coordinate system of a mother ship is τ_{pice} price:

$${τ}_{pice} = {[ {F}_{fz} , {F}_{c} , {F}_{fl} ]}^{T} {R}_{c}^{b}$$

wherein, input conditions comprise that, F_{c} is the compression force; F_{fz} and F_{fl} are friction forces; and R_{c}^{b} is a transformation matrix between local coordinates of the ship-ice contact surface and coordinates of the ship;
S34: in order to judge a fracture situation and shape characteristics of the flat ice making collision contact with the ship, calculating the bending failure load P_{f} of the flat ice, wherein a calculation model is as follows:

$${P}_{f} = {C}_{f} ( \frac{θ}{π} ) {σ}_{f} {h}_{i}^{2}$$

wherein, input conditions comprise that, C_{f} is an empirical parameter; σ_{f} is an ice bending strength; θ is the opening angle of the ice wedge at the ship-ice contact part, and hᵢ is the ice layer thickness; and
when a resultant force F_{z}=−F_{fz} sin φ+F cos φ of the compression force and friction force between the ship and the ice in a vertical direction is greater than a bending failure limit load P_{f}, the flat ice is broken, and the broken ice falls off;
S35: when the broken ice falling off is fan-shaped, expressing the shape characteristics of the broken ice falling off through a breaking radius and the opening angle of the ice wedge at the ship-ice contact part by a circular crack method, wherein a calculation model for the breaking radius R is as follows:

$$R = {{C}_{l} [ \frac{{{Eh}_{i}}^{3}}{12 ( 1 - {v}^{2} ) {ρ}_{w} g} ]}^{\frac{1}{4}} ( 1 + {C}_{v} {v}_{n} )$$

wherein, model input conditions comprise that, Cₗ and Cᵥ are empirical coefficients, v is a Poisson's ratio, and E is an ice elastic modulus; ρ_{w} is a seawater density; and vₙ is a relative normal speed between a discrete point of a waterline and a discrete point of a flat ice boundary; and
S36: after determining the shape characteristics (the breaking radius and the opening angle of the ice wedge at the ship-ice contact part) of the broken ice falling off, fracturing the broken ice falling off according to the distribution of sea ice issued by the trainer software, updating the flat ice boundary, expressing the distribution of the flat ice, and generating a boundary for the broken ice falling off from the flat ice, wherein, in a calculation process of the opening angle of the ice wedge at the ship-ice contact part, contact points between a waterline of a current position of the ship and two ends of the flat ice boundary obtained are traversed first, if a distance between the contact point and a discretized i^{th} flat ice boundary point is less than the breaking radius, and a distance between the contact point and a continuous (i+1)^{th} flat ice boundary point is greater than the breaking radius, then a fracture point is located between the continuous flat ice boundary points, and a distance between the fracture point and the contact point is equal to the breaking radius, so that the fracture points at two ends of the annular crack of the flat ice may be determined by a linear interpolation method; and then, a vertex of the ice wedge at the ship-ice contact part is determined through an intersection between a midperpendicular of the fracture points at two ends and a layer ice boundary, and an included angle between the vertex of the ice wedge and the fracture points at two ends is solved by an inverse trigonometric function, which is the opening angle of the ice wedge.

After the broken ice is generated by fracturing the flat ice, the broken ice moves as an independent object, and when there is ship-broken ice collision, the ship-broken ice collision simulation model is constructed through the ice field module, ship-broken ice, broken ice-broken ice, broken ice-flat ice solid surface contact forces are calculated respectively by steps, and a motion of each piece of independent broken ice in the ship navigation area under influences of wind, wave and current, and collision is calculated. This step specifically comprises the following steps:
S311: firstly, constructing a dynamic model of each piece of broken ice in the ship navigation area:

$$\{ \begin{matrix}{F}_{s} = {m}_{s} \frac{{dv}_{s}}{dt} \\ {T}_{s} = {J}_{s} \frac{d {ω}_{s}}{dt} + {ω}_{s} \times ( {J}_{s} \cdot {ω}_{s} )\end{matrix}$$

wherein, model input conditions comprise that, Fₛ is a combined external force generated by wind, wave and current forces exerted on the broken ice and contact forces with the flat ice, the broken ice and the ship; Tₛ is a combined external force moment; mₛ is a total mass of the broken ice calculated currently; and Jₛ is a total inertia tensor; and
inputting values of Fₛ, Tₛ, mₛ and Jₛ to obtain a speed vector vₛ of the motion of the broken ice; and an angular speed vector ωₛ, integrating to obtain displacement and rotation motion data of each piece of broken ice, and expressing the distribution of the broken ice;
S322: calculating a contact between solid surfaces of the broken ice by a linear spring damping system, wherein a calculation model for ship-broken ice, broken ice-broken ice and broken ice-flat ice contact forces near the ship is as follows:

$${F}_{n} = - {kd}_{n} - η {v}_{n}$$

$${F}_{t} = \{ \begin{matrix}- {kd}_{t} - η {v}_{t} , & \vert {d}_{t} \vert < \vert {d}_{n} \vert μ \\ \vert {kd}_{n} \vert μ \cdot {n}_{t} , & \vert {d}_{t} \vert \geq \vert {d}_{n} \vert μ\end{matrix}$$

wherein, model input conditions comprise that, k is a material elastic coefficient of ice; ζ is a material damping coefficient of ice; dₙ is a normal overlapping distance between the ice and other object, vₙ is a normal overlapping speed, dₜ is a tangential overlapping distance, vₜ is a tangential overlapping speed, and μ is a friction coefficient; n_{c} is a tangential unit direction of a broken ice boundary; and Fₙ is an inward normal contact force of the ice boundary, and Fₜ is a tangential contact force along the ice boundary; and
S333: finally, obtaining that the total load of the broken ice borne by the ship in a co-moving coordinate system of a mother ship is τ_{sice}:

$${τ}_{pice} = {[ {F}_{t} , {F}_{n} , 0 ]}^{T} {R}_{c}^{b}$$

wherein,

$${R}_{c}^{b}$$

IS a transformation matrix between local coordinates of the ship-ice contact surface and coordinates of the ship.

In fourth step: the polar-region ship sailing control simulation subsystem configures a fault situation of the thruster of the ship through the sailing and navigation control module according to the navigation task issued by the trainer software, and provides rotating speed and rudder angle control instructions for the propeller module and the rudder module of the polar-region ship real-time motion simulation subsystem by operating a thruster simulation control handle and a steering engine simulation control handle, so as to sail the ship in different directions.

In fifth step: the polar-region ship real-time motion simulation subsystem takes the wind load, the wave load, and the relative speed between the ship and the ocean current calculated in the S21 to the S23, the total load of the flat ice calculated in the S313, and the total load of the broken ice calculated in the S333 by the polar-region environment simulation subsystem as the environment load inputs, takes the rotating speed and the rudder angle provided by the polar-region ship sailing control simulation subsystem in the fourth step as the control instruction inputs, constructs the propeller model, the rudder model and the polar-region ship six-degree-of-freedom motion simulation model respectively by steps, and calculates the polar-region data of the ship navigation motion under influences of the wind, wave, current and ice loads. This step specifically comprises the following steps:

S51: taking, by the propeller module, the relative speed between the ship and the broken ice into account by constructing the propeller model of the ship, considering an influence of the broken ice on a performance of the propeller, and calculating the propeller thrust considering the influence of the ice according to a rotating speed instruction of the propeller provided by the polar-region ship sailing control simulation subsystem; wherein a calculation model for the propeller thrust affected by the broken ice is as follows:

$${T}_{P} = ( 1 - {t}_{p} ) {ρ}_{w} {{n}_{p}}^{2} {{D}_{p}}^{4} {K}_{T} ( \frac{( 1 - {W}_{p} ) u}{n \cdot {D}_{p}} )$$

wherein, model input conditions comprise that, tₚ is a deduction of the propeller thrust; ρ_{w} is a seawater density; nₚ is a rotating speed of the propeller; Dₚ is a diameter of the propeller; K_{T} is a thrust coefficient; Wₚ is a wake speed; u is a relative speed between the ship and the broken ice; and T_{P} is the propeller thrust;
S52: taking, by the rudder module, a flow speed at the rudder by constructing the rudder model, considering an influence of the ocean current on steerage, calculating the rudder force of the ship according to a rudder angle control instruction provided by the polar-region ship sailing control simulation subsystem, and controlling a ship navigation direction; wherein the rudder model is as follows:

$$\{ \begin{matrix}{C}_{L} = 2 π \frac{Λ ( Λ + 0.7 )}{{( Λ + 1.7 )}^{2}} sin δ + {C}_{Q} sin δ \vert sin δ \vert cos δ \\ {C}_{D} = \frac{{{C}_{L}}^{2}}{πΛ} + {C}_{Q} {\vert sin δ \vert}^{3} + 2.5 \frac{0.075}{{( log {R}_{n} - 2 )}^{2}}\end{matrix}$$

$$\{ \begin{matrix}{X}_{R} = - \frac{1}{2} {C}_{D} {ρ}_{w} {{v}_{f}}^{2} {A}_{r} \\ {Y}_{R} = \frac{1}{2} {C}_{L} {ρ}_{w} {{v}_{f}}^{2} {A}_{r} \\ {N}_{R} = \frac{1}{2} {C}_{L} {ρ}_{w} {{v}_{f}}^{2} {A}_{r} {x}_{r}\end{matrix}$$

wherein, model input conditions comprise that: C_{L} is a lift coefficient of the rudder; C_{D} is a drag force coefficient of the rudder; Λ is an aspect ratio of the rudder; δ is the rudder angle; Rₙ is a Reynolds number of the rudder; C_{Q} is a prismatic coefficient, which is about 1 when upper and lower edges of the rudder are sharp; v_{f} is the flow speed at the rudder, which is 1.25 times of a ship navigation speed; ρ_{w} is the seawater density; Aᵣ is a rudder area; xᵣ is a distance from the rudder to a midstation plane, and a negative value is taken for a stern rudder; and
calculation results of the model are: rudder forces X_{R}, N_{R}, Y_{R} in longitudinal, transverse and vertical directions in a coordinate system; and
S53: taking, by the ship module, the wind load, the wave load and the relative speed between the ship and the ocean current into account by constructing the polar-region ship six-degree-of-freedom motion simulation model, considering influences of the wind, wave and current environmental conditions on a ship motion, taking the total load of the flat ice and the total load of the broken ice into account, considering an influence of the ice on the ship motion, taking the propeller thrust and the rudder force into account to control a ship navigation state, and obtaining ship six-degree-of-freedom motion data by integral calculation; and
calculating a hydrodynamic coefficient and a time delay function of the mother ship according to a contour of the mother ship, and constructing the ship six-degree-of-freedom motion simulation model according to an ice situation and an ocean state of the broken ice area:

$${M}_{0} {\dot{v}}_{0} + {C}_{RB 0} {v}_{0} + {C}_{A 0} {v}_{r 0} + {D}_{0} {v}_{r 0} + {\int }_{0}^{t} {K}_{0} ( t - γ ) [ {v}_{0} ( γ ) - {Ue}_{1} ] d γ + {G}_{0} η = {τ}_{wind 0} + {τ}_{wave 0} + {τ}_{P} + {τ}_{R} + {τ}_{ice}$$

wherein, model input conditions comprise that: M₀ is a sum of a mass of the mother ship and an additional mass; C_{RB0} is a centripetal force of a rigid body and a liquid body, and C_{A0} is a Coriolis force matrix; vᵣ₀ is a relative speed between the mother ship and the ocean current in the co-moving coordinate system; D₀ is a damping matrix; K₀(t−γ) is a time delay function, wherein t is simulation time and γ is an integral variable; U is a longitudinal navigation speed of the mother ship; e₁ is a longitudinal unit vector; G₀ is a stiffness matrix of the mother ship; τ_{wind0} is the wind load; τ_{wave0} is the wave load; τ_{P} is the propeller thrust; τ_{R} is the rudder force of the ship; and τ_{ice} is a total ice load, comprising a flat ice load τ_{pice} and a broken ice load τ_{sice}; and
solving to obtain an acceleration \dot{v}₀ and a speed v₀ of polar-region ship navigation, and integrating by fourth-order Runge-Kutta to obtain a posture of the ship motion.

In sixth step: the polar ship navigation vision simulation subsystem carries out three-dimensional scene simulation based on a three-dimensional engine Unreal Engine, the initial position of the ship and the initial distribution of the flat ice and the broken ice are loaded according to the navigation sea area and the wind, wave and current environmental conditions issued by the trainer software in the simulation process, and the three-dimensional engine is driven to render the three-dimensional model of the marine environment, the atmospheric environment, the ice area and the ship to generate the three-dimensional scene; the boundary and shape of the flat ice in the three-dimensional scene are updated according to characteristic data of the breaking of the flat ice (the breaking radius and the opening angle of the ice wedge at the ship-ice contact part) calculated in the third step; and the distribution of the broken ice in the three-dimensional scene is updated according to data of the motion of the broken ice (the displacement and rotation of each piece of broken ice), and a posture of ship navigation in the three-dimensional scene is updated according to data of the posture of the ship motion calculated in the fifth step.

Any process or method described in the flow charts in FIG. 1 and FIG. 2 or described in other ways herein may be understood as representing a module, segment or part comprising codes of one or N executable instructions for implementing customized logic functions or process steps, and the scope of the preferred embodiments of the present invention comprises other implementations, wherein the functions may be executed out of the order shown or discussed, such as executing in a substantially simultaneous manner or in a reverse order according to the functions involved, which should be understood by those skilled in the technical field to which the embodiments of the present invention belong. The logics and/or steps represented in the flow charts or described in other ways herein illustrate system architectures, functions and operations that are possible to be implemented according to the apparatus and the method according to various embodiments of the present disclosure. In this regard, each block in the flow chart or the block diagram may represent one module, one program segment, or a part of code. The module, the program segment, or the part of code contains one or more executable instructions for implementing specified logical functions. It should also be noted that in some alternative implementations, the functions noted in the blocks may also occur in a different order from those noted in the drawings. For example, two consecutively shown blocks may actually be executed in substantially parallel, and sometimes may be executed in a reverse order, depending on the functions involved. It should also be noted that each block in the block diagrams or the flow charts, and the combinations of the blocks in the block diagrams or the flow charts may be implemented with dedicated hardware-based systems that execute specified functions or operations, or may be implemented with the combinations of dedicated hardware and computer instructions. For example, it may be regarded as the sequence list of executable instructions for implementing logic functions, and may be specifically implemented in any computer-readable medium for use by or in combination with an instruction execution system, apparatus or device (such as a computer-based system, a system including a processor or other systems that can receive and execute the instructions from the instruction execution system, apparatus or device).

It can be understood by those skilled in the art that the above are only the preferred embodiments of the present invention, and the features described in various embodiments and/or claims of the present disclosure may be combined or integrated in various ways, even if such combinations or integrations are not explicitly described in the present disclosure, which are not used to limit the present invention. Although the present invention has been described in detail with reference to the above embodiments, it is still possible for those skilled in the art to modify the technical solutions described in the above embodiments, or to substitute some technical features by equivalents. Any modification, equivalent substitution, improvement, etc. made within the spirit and principle of the present invention should be included in the scope of protection of the present invention.

Although the preferred embodiments of the present invention have been described, those skilled in the art can make additional changes and modifications to these embodiments once they know the basic inventive concepts. Therefore, the appended claims are intended to be interpreted as comprising the preferred embodiments and all the changes and modifications that fall within the scope of the present invention. Obviously, those skilled in the art may make various modifications and variations to the present invention without departing from the spirit and scope of the present invention. Therefore, if these modifications and variations of the present invention fall within the scope of the claims of the present invention and their equivalents, the present invention is also intended to comprise these modifications and variations.

What is claimed is:

1. A polar-region ship navigation simulation system, wherein the polar-region ship navigation simulation system comprises a comprehensive management and evaluation subsystem, a ship sailing control simulation subsystem, a polar-region working environment simulation subsystem, a polar-region ship real-time motion simulation subsystem and a polar-region ship navigation vision simulation subsystem;
the comprehensive management and evaluation subsystem comprises trainer software and electronic chart software, wherein the trainer software is used for providing input conditions of polar-region environment and ice layer distribution for the polar-region working environment simulation subsystem; and the electronic chart software is used for providing an initial position of a ship and a route plan for the polar-region ship motion simulation subsystem in real time, and controlling a simulation process of the simulation system at the same time;
the ship real-time motion simulation subsystem comprises a thruster operation module, a steering engine operation module and a sailing and navigation control module; and is used for providing a rotating speed of a propeller, a rudder angle and a fault control instruction of a thruster for the polar-region ship real-time motion simulation subsystem, and used for simulating ship navigation control;
the polar-region working environment simulation subsystem comprises a wind speed module, a wave field module, a flow speed module and an ice field module; and calculates a polar-region environment load, an ice load, and data of ice breaking and motion by constructing a ship-flat ice collision model and a ship-broken ice collision model;
the polar-region ship real-time motion simulation subsystem comprises a propeller module, a rudder module and a ship module, and calculates a ship motion considering influences of wind, wave, current and ice loads by constructing a ship six-degree-of-freedom motion simulation model; and
the polar-region ship navigation vision simulation subsystem receives the data of ice breaking and motion calculated by the polar-region working environment simulation subsystem and data of the ship motion calculated by the polar-region ship real-time motion simulation subsystem, and is used for displaying and updating scenes of polar-region navigation, atmosphere, ocean and ice field in real time.

2. The polar-region ship navigation simulation system according to claim 1, wherein the polar-region ship navigation vision simulation subsystem comprises a polar-region ship motion simulation driving module, a sea ice motion simulation driving module, a polar-region environment simulation module and a polar-region navigation auxiliary information display module;
the polar-region ship motion simulation driving module is configured for receiving and updating a motion posture in polar-region ship navigation in real time;
the sea ice motion simulation driving module is configured for receiving and updating distribution of floating ice in a ship navigation area in real time;
the polar-region environment simulation module is configured for synchronously updating a polar-region environment according to a trainer instruction; and
the polar-region navigation auxiliary information display module is configured for dynamically displaying an ice layer thickness and an interference distance in vision.

3. A polar-region ship navigation simulation modeling method, wherein the polar-region ship navigation simulation modeling method is implemented by the system according to any claim 1, and the polar-region ship navigation simulation modeling method comprises the following steps:
first step: setting environment conditions, sea ice conditions, the initial position of the ship and an expected navigation trajectory through the trainer software and the electronic chart software of the comprehensive management and evaluation subsystem, and issuing a simulation task;
second step: according to the simulation task issued in the first step, calculating, by the polar-region environment simulation subsystem, wind, wave and current loads through the wind speed module, the wave field module and the flow speed module according to the set environment conditions, traversing a ship waterplane boundary point and nearby flat ice and broken ice boundary points by a multi-thread parallel programming method, and detecting a ship-ice contact situation;
third step: on the basis of detecting the ship-ice contact situation in the second step, when the ship-ice contact is detected, calculating, by the ice field module, breaking of flat ice, a motion of broken ice, and total loads of the flat ice and the broken ice based on the ship-flat ice collision model and the ship-broken ice collision model according to distribution of sea ice, an ice layer thickness and a material property;
fourth step: taking, by the polar-region ship real-time motion simulation subsystem, the wind load, the wave load, a relative speed between the ship and an ocean current, the total load of the flat ice and the total load of the broken ice calculated by the polar-region environment simulation subsystem as environment load inputs, taking the rotating speed and the rudder angle provided by the polar-region ship sailing control simulation subsystem as control instruction inputs, and constructing a propeller model, a rudder model and a polar-region ship six-degree-of-freedom motion simulation model respectively; and
fifth step: generating, by the polar-region ship navigation vision simulation subsystem, a three-dimensional scene according to a navigation sea area, and wind, wave and current environmental conditions issued by the trainer software, updating distribution of the flat ice and the broken ice according to data of the breaking characteristic of the flat ice and data of the motion of the broken ice calculated by the polar-region environment simulation subsystem, and updating a polar-region ship navigation simulation three-dimensional scene according to data of the ship navigation motion calculated by the polar-region ship real-time motion simulation subsystem.

4. The polar-region ship navigation simulation modeling method according to claim 3, wherein the third step further comprises a step of calculating a ship-ice contact area, a compression force and friction force between the ship and the ice, and a bending failure load of the flat ice respectively, judging a breaking situation of the flat ice, and expressing shape characteristics of the broken ice falling off after the flat ice is broken through a radius of the broken ice falling off and an opening angle of an ice wedge.

5. The polar-region ship navigation simulation modeling method according to claim 4, wherein the calculating the ship-ice contact area, the compression force and friction force between the ship and the ice, and the bending failure load of the flat ice, judging the breaking situation of the flat ice, and expressing the shape characteristics of the broken ice falling off after the flat ice is broken through the radius of the broken ice falling off and the opening angle of the ice wedge in the third step, specifically comprises the following steps:
S31: firstly, judging a shape of a ship-ice contact part through the ice layer thickness hᵢ, an included angle φ between a normal direction outside the ship and a downward vertical axis at the ship-ice contact part, and a compression depth L_{d}, and calculating a ship-flat ice contact area A_{c}, by the ship-flat ice collision model as follows:
$${A}_{c} = \{ \begin{matrix}\frac{1}{2} {L}_{h} \frac{{L}_{d}}{cos φ} , & {L}_{d} tan φ \leq {h}_{i} \\ \frac{1}{2} ( {L}_{h} + {L}_{h} \frac{{L}_{d} - \frac{{h}_{i}}{tan φ}}{{L}_{d}} ) \frac{{h}_{i}}{sin φ} , & {L}_{d} tan φ > {h}_{i}\end{matrix}$$
wherein, Lₕ is a length of a ship boundary where a horizontal ice surface makes contact with an ice boundary; L_{d} is the compression depth of the ship into the ice boundary on the horizontal ice surface; φ is the included angle between the normal direction outside the ship and the downward vertical axis at the ship-ice contact part; and hᵢ is the ice layer thickness;
S32: secondly, calculating the compression force F_{c} and friction force F_{f} between the ship and the ice respectively through the ship-flat ice contact area A_{c} by the ship-flat ice collision model as follows:
$${F}_{c} = {n}_{c} \cdot {σ}_{c} {A}_{c}$$
$${F}_{fz} = - {τ}_{c} \cdot {μ}_{f} {F}_{c} {v}_{z} / V$$
$${F}_{fl} = - {τ}_{c} \cdot {μ}_{f} {F}_{c} {v}_{l} / V$$
wherein, n_{c} is a unit normal direction of a ship-ice contact surface; σ_{c} is a compression strength of ice; τ_{c} is a unit tangential direction of the ship-ice contact surface; μ_{f} is a ship-ice friction coefficient; F_{fz} is an upward friction force along the ship-ice contact surface; v_{z} is an upward relative speed between the ship and the ice along the ship-ice contact surface; F_{fl} is a friction force along a horizontal direction of the ship-ice contact surface; vₗ is a relative speed between the ship and the ice along the horizontal direction of the ship-ice contact surface; and V is a total speed of the ship sliding relative to the ice;
S33: finally, obtaining that the total load of the flat ice borne by the ship in a co-moving coordinate system of a mother ship is τ_{pice}:
$${τ}_{pice} = {[ {F}_{fz} , {F}_{c} , {F}_{fl} ]}^{T} {R}_{c}^{b}$$
wherein,
$${R}_{c}^{b}$$
is a transformation matrix between local coordinates of the ship-ice contact surface and coordinates of the ship;
S34: in order to judge a fracture situation and shape characteristics of the flat ice making collision contact with the ship, calculating the bending failure load P_{f} of the flat ice by the ship-broken ice collision model as follows:
$${P}_{f} = {{C}_{f} ( \frac{θ}{π} )}^{2} {σ}_{f} {h}_{i}^{2}$$
wherein, C_{f} is an empirical parameter; σ_{f} is an ice bending strength; θ is the opening angle of the ice wedge at the ship-ice contact part, and hᵢ is the ice layer thickness; and
when a resultant force F_{z}=−F_{fz} sin φ+F cos φ of the compression force and friction force between the ship and the ice in a vertical direction is greater than a bending failure limit load P_{f}, the flat ice is broken, and the broken ice falls off;
S35: when the broken ice falling off is fan-shaped, expressing the shape characteristics of the broken ice falling off through a breaking radius and the opening angle of the ice wedge at the ship-ice contact part by a circular crack method, wherein a calculation model for the breaking radius R is as follows:
$$R = {{C}_{l} [ \frac{{{Eh}_{i}}^{3}}{12 ( 1 - {v}^{2} ) {ρ}_{w} g} ]}^{\frac{1}{4}} ( 1 + {C}_{v} {v}_{n} )$$
wherein, Cₗ and Cᵥ are empirical coefficients, v is a Poisson's ratio, and E is an ice elastic modulus; ρ_{w} is a seawater density; and vₙ is a relative normal speed between a discrete point of a waterline and a discrete point of a flat ice boundary; and
S36: after determining the breaking radius and the opening angle of the ice wedge at the ship-ice contact part in the shape characteristics of the broken ice falling off, fracturing the broken ice falling off according to the distribution of sea ice issued by the trainer software, updating the flat ice boundary, expressing the distribution of the flat ice, and generating a boundary for the broken ice falling off from the flat ice.

6. The polar-region ship navigation simulation modeling method according to claim 3, wherein the, when the ship-ice contact is detected, calculating, by the ice field module, the breaking of the flat ice, the motion of the broken ice, and the total loads of the flat ice and the broken ice based on the ship-flat ice collision model and the ship-broken ice collision model according to the distribution of sea ice, the ice layer thickness and the material property in the third step, is implemented by a method comprising:
S311: firstly, constructing a dynamic model of each piece of broken ice in the ship navigation area:
$$\{ \begin{matrix}{F}_{s} = {m}_{s} \frac{{dv}_{s}}{dt} \\ {T}_{s} = {J}_{s} \frac{d {ω}_{s}}{dt} + {ω}_{s} \times ( {J}_{s} \cdot {ω}_{s} )\end{matrix}$$
wherein, Fₛ is a combined external force generated by wind, wave and current forces exerted on the broken ice and contact forces with the flat ice, the broken ice and the ship; Tₛ is a combined external force moment; mₛ is a total mass of the broken ice calculated currently; and Jₛ is a total inertia tensor; and
inputting values of Fₛ, Tₛ, mₛ and Jₛ to obtain a speed vector vₛ of the motion of the broken ice; and an angular speed vector ωₛ, integrating to obtain displacement and rotation motion data of each piece of broken ice, and expressing the distribution of the broken ice;
S322: calculating a contact between solid surfaces of the broken ice by a linear spring damping system, wherein a calculation model for ship-broken ice, broken ice-broken ice and broken ice-flat ice contact forces near the ship is as follows:
$${F}_{n} = - {kd}_{n} - η {v}_{n}$$
$${F}_{t} = \{ \begin{matrix}- {kd}_{t} - η {v}_{t} , & \vert {d}_{t} \vert < \vert {d}_{n} \vert μ \\ \vert {kd}_{n} \vert μ \cdot {n}_{t} , & \vert {d}_{t} \vert \geq \vert {d}_{n} \vert μ\end{matrix}$$
wherein, k is a material elastic coefficient of ice; η is a material damping coefficient of ice; dₙ is a normal overlapping distance between the ice and other object, vₙ is a normal overlapping speed, dₜ is a tangential overlapping distance, vₜ is a tangential overlapping speed, and μ is a friction coefficient; nₜ is a tangential unit direction of a broken ice boundary; and Fₙ is an inward normal contact force of the ice boundary, and Fₜ is a tangential contact force along the ice boundary; and
S333: finally, obtaining that the total load of the broken ice borne by the ship in a co-moving coordinate system of a mother ship is τ_{ice}:
$${τ}_{pice} = {[ {F}_{t} , {F}_{n} , 0 ]}^{T} {R}_{c}^{b}$$
wherein,
$${R}_{c}^{b}$$
is a transformation matrix between local coordinates of the ship-ice contact surface and coordinates of the ship.

7. The polar-region ship navigation simulation modeling method according to claim 3, wherein the taking the rotating speed and the rudder angle provided by the polar-region ship sailing control simulation subsystem as the control instructions to calculate a propeller thrust affected by the ice in the fourth step, that is, the calculation of the propeller thrust τ_{P} affected by the broken ice, is implemented by a method as follows:
$${T}_{P} = ( 1 - {t}_{p} ) {ρ}_{w} {{n}_{p}}^{2} {{D}_{p}}^{4} {K}_{T} ( \frac{( 1 - {W}_{p} ) u}{n \cdot {D}_{p}} )$$
wherein, tₚ is a deduction of the propeller thrust; ρ_{w} is a seawater density; nₚ is a rotating speed of the propeller; Dₚ is a diameter of the propeller; K_{T} is a thrust coefficient; Wₚ is a wake speed; u is a relative speed between the ship and the broken ice; and τ_{P} is the propeller thrust.

8. The polar-region ship navigation simulation modeling method according to claim 3, wherein the constructing the ship six-degree-of-freedom motion simulation model in the fourth step, is implemented by a method as follows:
$${M}_{0} {\dot{v}}_{0} + {C}_{RB 0} {v}_{0} + {C}_{A 0} {v}_{r 0} + {D}_{0} {v}_{r 0} + {\int }_{0}^{t} {K}_{0} ( t - γ ) [ {v}_{0} ( γ ) - {Ue}_{1} ] d γ + {G}_{0} η = {τ}_{wind 0} + {τ}_{wave 0} + {τ}_{P} + {τ}_{R} + {τ}_{ice}$$
wherein, M₀ is a sum of a mass of the mother ship and an additional mass; C_{RB0} is a centripetal force of a rigid body and a liquid body, and C_{A0} is a Coriolis force matrix; vᵣ₀ is a relative speed between the mother ship and the ocean current in the co-moving coordinate system; D₀ is a damping matrix; K₀(t−γ) is a time delay function, wherein t is simulation time and γ is an integral variable; U is a longitudinal navigation speed of the mother ship; e₁ is a longitudinal unit vector; G₀ is a stiffness matrix of the mother ship; τ_{wind0} is the wind load; τ_{wave0} is the wave load; τ_{P} is the propeller thrust; τ_{P} is the rudder force of the ship; and τ_{ice} is a total ice load, comprising a flat ice load τ_{pice} and a broken ice load τₛ; and
solving to obtain an acceleration \dot{v}₀ and a speed v₀ of polar-region ship navigation, and integrating by fourth-order Runge-Kutta to obtain a posture of the ship motion.

9. The polar-region ship navigation simulation modeling method according to claim 3, wherein the generating, by the polar-region ship navigation vision simulation subsystem, the three-dimensional scene according to the navigation sea area, and the wind, wave and current environmental conditions issued by the trainer software in the fifth step, is implemented by a method comprising: simulating, by the polar-region ship navigation vision simulation subsystem, the three-dimensional scene based on a three-dimensional engine, loading the initial position of the ship and the initial distribution of the flat ice and the broken ice through the navigation sea area and the wind, wave and current environmental conditions issued by the trainer software in the simulation process, and driving the three-dimensional engine to render a three-dimensional model of marine environment, atmospheric environment, an ice area and the ship to generate the three-dimensional scene.
